(19) United States
(12) Patent Application Publication
(10) Pub. No.: US 2007/0123242 A1
(43) Pub. Date: May 31, 2007

(54) Device and method for selecting an application for a mobile handset

(76) Inventors: Matthew Shapiro, Hod Hasharon (IL); Shlomo Goldman, Jerusalem (IL); Shimon Constante, Herzelia (IL)

Correspondence Address: DANIEL J SWIRSKY, 55 REUVEN ST., BEIT SHEMESH, 99544, IL

(21) Appl. No.: 11/504,097

(22) Filed: Aug. 15, 2006

Related U.S. Application Data
(60) Provisional application No. 60/708,191, filed on Aug. 15, 2005.

(51) Int. Cl. H04M 3/00

(52) U.S. Cl. 455/418

(57) ABSTRACT

A memory suitable for inserting and removing from a handset, where the memory stores instructions to identify an operating system and firmware of the handset, select an application that is compatible with operating system and the firmware and install the compatible application on the handset.

### CROSS-REFERENCE TO RELATED APPLICATIONS

This application claims priority from U.S. Provisional Patent Application No. 60/708,191, filed Aug. 15, 2005, and entitled “Cross platform wireless content and application Installation and ubiquitous formatting,” which is hereby incorporated by reference herein in its entirety.

### BACKGROUND OF THE INVENTION

Installing an application on a mobile handset is beyond the technical sophistication of many users of such handsets. Many applications that are intended to be wirelessly downloaded and installed onto a handset require a user to know the operating system running on his phone or handset, and to configure the download and installation of the application to match such operating system. Many users consider this process burdensome and a deterrent to downloading applications.

### SUMMARY OF THE INVENTION

Some embodiments of the invention include a device having a memory suitable for inserting into and removing from a handset. The memory may include instructions such as for example software that when executed results in identifying an operating system and firmware that may run on the handset, selecting an application stored on the memory that is compatible with the identified operating system and the firmware, and installing the application on the handset so that the installed application is compatible with the operating system and firmware. In some embodiments, the installed application may select another or second application or set of instructions that may be stored on the memory, and may prompt a user of the handset to approve an installation of the second application on the handset and may install the second application on the handset.

In some embodiments, the memory may store instructions that when executed result in wirelessly receiving data from a remote device such as a remote server, and data may be sent from the remote device to the handset to update information stored on the handset.

In some embodiments, the memory may store instructions that when executed result in the handset wirelessly transmitting data to a remote device, where such data includes information on advertisement views of the handset.

In some embodiments, the memory may store instructions that when executed result in selecting an application from among more than one version of the application that may be stored on the memory, where some of the other versions of the application are operable with other operating systems.

In some embodiments, the memory may store instructions that when executed result in collecting data from the handset, where the collected data may include any or all of for example a phone number of the handset, a model of the handset, identification data of the memory card, a host operator of the handset and/or a geographical area of operation of the handset. In some embodiments, some or all of such data may be transmitted to a remote device such as a server, and the server may register the handset and the collected information.

In some embodiments, the memory may store instructions that when executed result in blocking from the memory a storage of data that does not match a pre-defined criteria, where the criteria may include an appearance of such application or data on a pre-defined list. In some embodiments the instructions may result in deleting from the memory versions of an application that are not compatible with the operating system and firmware.

In some embodiments, if a selected version of an application is not found on the memory, the instructions may result in the handset transmitting a signal to a remote device such as a server, and requesting to receive a compatible version of the application from the server.

### BRIEF DESCRIPTION OF THE FIGURES

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic diagram of a device including a memory for storing instructions that detect an operating system of a handset, and for installing an application that is compatible with such operating system, in accordance with an embodiment of the invention;

FIG. 2 is schematic diagram of applications stored on a memory device for insertion and removal from a handset in accordance with an embodiment of the invention;

FIG. 3 is a flow chart of a method in accordance with an embodiment of the invention; and

FIG. 4 is a flow chart of a method in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following description, various embodiments of the invention will be described. For purposes of explanation, specific examples are set forth in order to provide a thorough understanding of at least one embodiment of the invention. However, it will also be apparent to one skilled in the art that other embodiments of the invention are not limited to the examples described herein. Furthermore, well-known features may be omitted or simplified in order not to obscure embodiments of the invention described herein.

Unless specifically stated otherwise, as apparent from the following discussions, it is appreciated that throughout the specification, discussions utilizing terms such as “selecting,” “processing,” “computing,” “calculating,” “determining,” or the like, may refer to the actions and/or processes of a computer, computer processor or computing system, or similar electronic computing device, that may manipulate and/or transform data represented as physical, such as electronic quantities within the computing system's registers and/or memories into other data similarly represented as physical quantities within the computing system's memories, registers or other such information storage, transmission or display devices. In some embodiments processing, computing, calculating, determining, selecting and other data manipulations may be performed by one or more processors that may in some embodiments be linked.

The processes and functions presented herein are not inherently related to any particular computer, handset, network or other apparatus. Embodiments of the invention described herein are not described with reference to any particular programming language, machine code, etc. It will be appreciated that a variety of programming languages, network systems, protocols or hardware configurations may be used to implement the teachings of the embodiments of the invention as described herein.

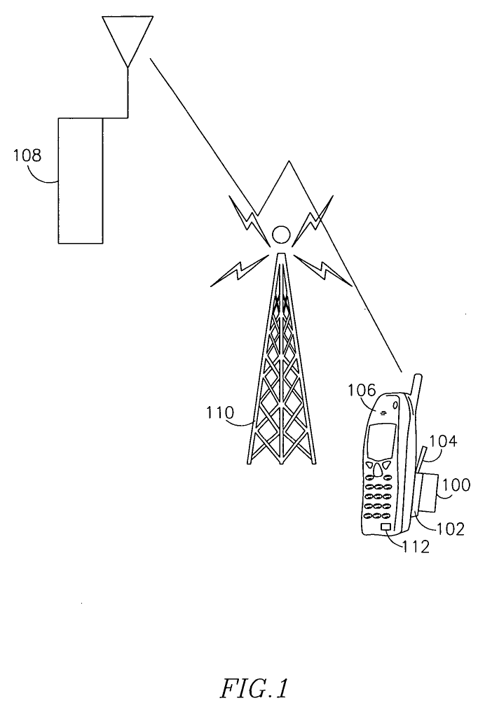

Reference is made to FIG. 1, a schematic diagram of a device including a memory for storing instructions that detect an operating system of a handset and for installing an application that is compatible with such operating system, in accordance with an embodiment of the invention. In some embodiments, a device may include for example a memory card 100 or other mass data storage unit that may be for example inserted into and removed from a handset by for example a user or other operator. In some embodiments, memory card 100 may be inserted in a slot 102 of a handset 106 that may for example be exposed or closed by a latch 104. In some embodiments, opening or closing latch 104, or insertion of a memory card 100 into slot 102 may initiate a function in handset 106 that may scan memory card 100 or otherwise initiate or run a detection of identification data, applications, installers or other characteristics of memory card 100.

In some embodiments, handset 106 may be or include a cellular phone, a personal digital assistant, a beeper, a portable email manager, or other generally portable electronic device capable of wireless transmission and receipt of data over a network. In some embodiments, a network may include for example, one or more servers 108 such as a cellular server that may transmit to or from a cellular antenna 110, and that may receive data and communication signals from one or more handsets 106 and one or more servers 108. Servers 108 may transmit data and applications to one or more handsets 106.

In some embodiments, handset 106 may include an internal or fixed memory 112, such as for example a flash memory or other mass data storage device that may store data, operating systems or other applications that may run or operate handset 106. For example, memory 112 may store data relating to the version of an operating system as well as firmware that may run on handset 106, a phone number of handset 106, a model number of handset 106, a location such as a country wherein handset 106 is based or operating, and a cellular or host carrier used by handset 106. Other data may be stored on memory 112.

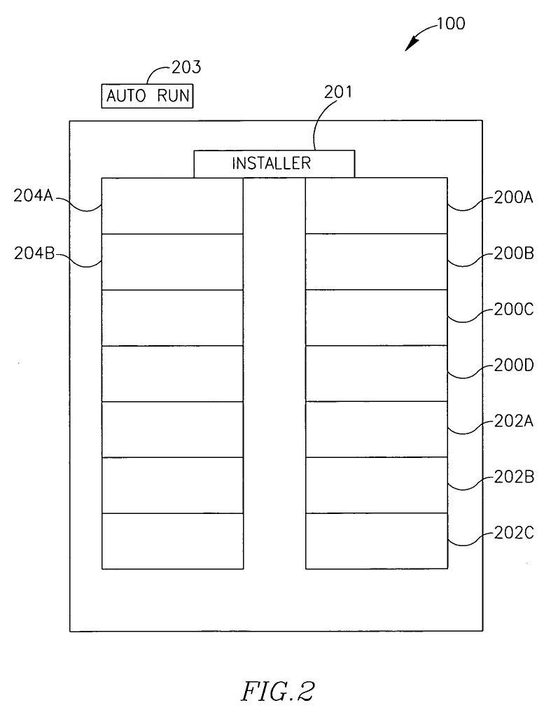

Reference is made to FIG. 2, a schematic diagram of applications stored on a memory device that may be inserted and removed from a handset in accordance with an embodiment of the invention. In some embodiments, memory card 100 may include or store several applications 200 such as for example programs or routines. Memory card 100 may store more than one version of an application 200, such as for example application versions 200A, 200B, 200C and 220D. One of such versions 200A may be compatible with a particular operating system and firmware that may be running on a particular handset, and another version 200B may be compatible with another operating system and firmware that may be running on another handset. For example, application version 200A may be compatible with a Symbian™ UIQ operating system and Nokia™661RRN36 firmware, such that version 200A of the application will run on a particular handset produced by Nokia. Another version 200B may run on or be compatible with for example a Windows™Mobile operating system and Samsung 661URH11 firmware, such that version 200B will run on a handset produced by Samsung. Other combinations of operating systems, firmware and versions are possible.

In some embodiments, memory card 100 may store other applications 202 and 204 in more than one version such as for example 202A, 202B, 202C, 204A, 204B, where a version of such other applications are also compatible with one or more particular operating system and firmware that may run on a handset.

In some embodiments, and referring back to FIG. 1, memory 112 or another memory may include for example a set of instructions or program such as for example an auto run program 203 that may find and initiate the execution of installer 201 that may be stored on memory card 100. For example, auto run 203 may run when for example memory card 100 is inserted into slot 102 and latch 104 is closed.

In operation and in some embodiments, memory card 100 may be inserted into slot 102 of handset 106, and latch 104 may be closed to activate auto run 203. Auto run 203 may scan memory card 100 or look for an installation program such as installer 210 on memory card 100. Other processes, whether automatically or manually initiated, may activate installer 210. Upon activation, instructions in installer 210 may be executed, and such instructions may trigger a scan for example of memory 112 to find for example a driver or other data that may be stored there that may include an operating system and firmware that are running on handset 106. Installer 210 or another routine on memory card 100 may at that time or at a later time collect data on the phone number, host phone type, cellular carrier, identification information of the memory card itself, and location of handset 106. Other data may be collected.

Installer or another application may select a version of an application 200A that is compatible with or operable on the particular operating system and firmware that were detected by installer 201. In some embodiments, installer 210 may signal or instruct the selected version to be installed on handset 106.

In some embodiments, other versions of the installed application 200, such as for example version 200B, 200C, and 200D may be deleted from memory card 100, and the memory space that had been devoted to or reserved for storing those other versions may be freed to store data or other applications.

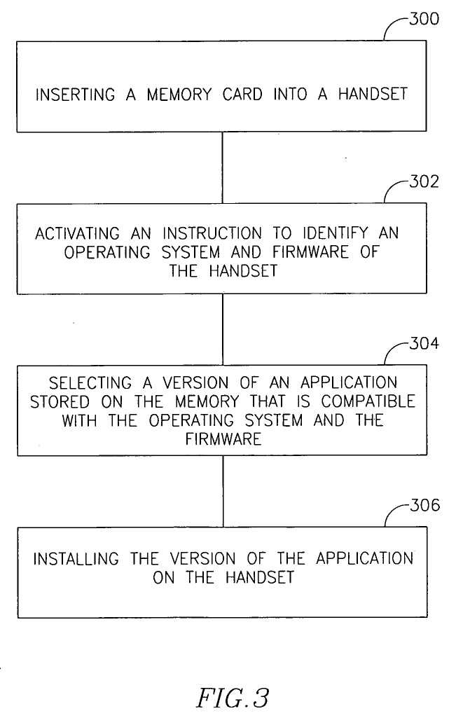

Reference is made to FIG. 3, a flow chart of a method in accordance with an embodiment of the invention. In block 300, a memory card or other memory or mass data storage device may be inserted, brought into contact with or otherwise activated in a handset. In some embodiments, the handset may include an auto run function that may find and run an installer application on the inserted memory card. In some embodiments the memory card may store more than one version of an application.

In block 302, an application stored on the memory card may collect and identify data about the handset, such as for example an operating system running on the handset, firmware running on the handset, a phone number of the handset, a cellular carrier or host operator used by the hand set, a phone type or model and other data or identification information of the handset or of the memory card itself. In some embodiments, some or all of such collected data may be transmitted to for example a remote server, where the handset may be registered according to such information. Such registration may for example, facilitate transmissions to such handset by a remote server of data or applications that are compatible with the operating system and firmware of the handset.

In block 304, an installer program or other set of instructions may select a version of an application that may be stored on the inserted memory to find the version of an application that is compatible with the identified operating system and the firmware and other data found or detected in the handset.

In block 306, the installer program or another set of instructions may install the selected version of the application on the handset. In some embodiments, the selected version of the application may trigger the installation of other applications that may for example be stored on the memory, where the other applications are also installed using the version of such other applications that fits or is compatible with the operating system and firmware that is running on the handset.

In some embodiments, the application that may be originally or first installed from the memory card onto the handset, or that may be installed at a later time, may issue a wireless signal on for example a cellular or other network to a remote server, where such signal requests the remote server to wirelessly transmit to the handset another application in the version that is compatible with the detected operating system and firmware. Once received, the downloaded application may be saved on the memory card and/or installed on the handset.

In some embodiments, an application that may be stored on the memory card and/or installed in the handset may issue a signal that a remote server transmit to the hand set data or other content that may be displayed on a screen of the handset. For example, a version of a browser that may be stored on a memory card may be installed on a handset by an installer program, and then the browser may signal a remote server to transmit news, images, games, video or other content or applications to a handset, and such content or applications may be stored on a memory card in the handset and/or displayed on a screen of the handset. In some embodiments, the data may be downloaded or streamed to the handset, and may be stored or viewed in for example an XML format or other mark-up language or format.

In some embodiments, an application that may be stored on a memory card in the handset may issue a signal to the handset to transmit for example registration data to a remote server. The remote server may record the data and periodically transmit updates of a particular program or application to the handset. The updates of a program such as for example an anti-virus program, browser or other program may be stored on the memory card and installed on the handset.

In some embodiments, the memory card may store for example advertisements or promotional materials. An application may at various times trigger the display of the advertisement or promotional materials on a screen of the handset. The application may at various intervals transmit data to a remote server that may track the display of such promotional materials on the handset, the number or nature of views that a user of the handset may have responded to, and for examples reactions to such views by a user of the handset.

In some embodiments, an application installed on the handset from the memory device may select a second application stored on the memory that is also compatible with the operating system and the firmware, and may prompt a user of the handset to decide whether to install or approve installation of the second application, and the first application, may upon such approval, install the second application on the handset.

In some embodiments one or more applications that may be installed on a handset may install an instruction that requires that all further downloads of applications onto the handset from a remote server be installed through a particular application that was stored on the memory card and then installed application. For example, an application that is originally installed on a handset may select and install the compatible installer program onto the handset. The installer program may then limit installation of other programs onto the handset, or storage on the memory card, to those programs or applications that are listed on the memory card or otherwise authorized for storage or installation by an application on the memory card or that match a pre-defined criteria. Similarly, the application may block storage into the memory card or installation on the handset of unauthorized data or applications.

In some embodiments, an application such as for example an installer program may delete versions of applications or other data stored on the memory card, where such other versions or data are not compatible with the operating system and firmware operating on the handset or is compatible only with other operating systems and firmware, and the memory segments or areas of the memory card that stored the deleted versions may be freed to store other data or applications.

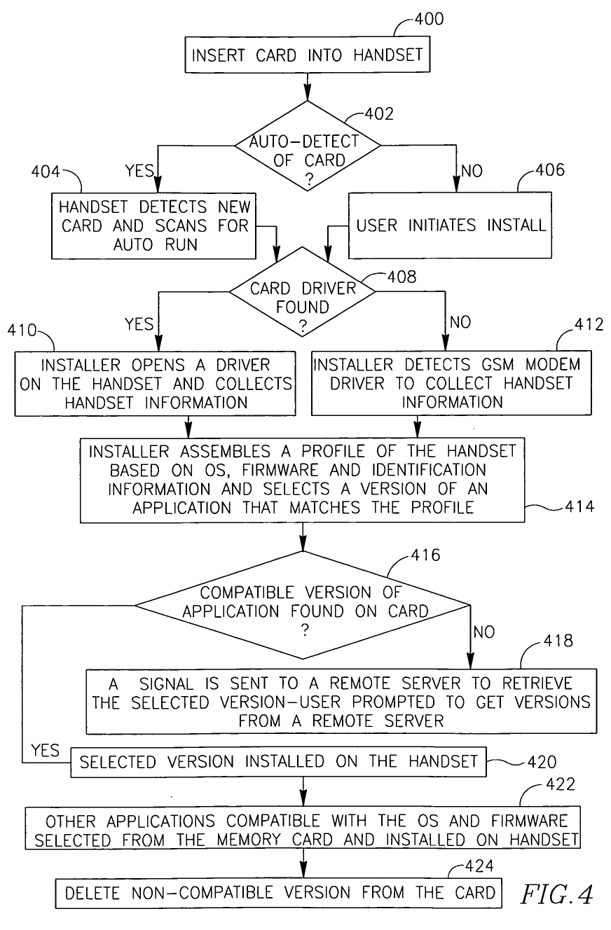

Reference is made to FIG. 4, a flow chart of a method in accordance with an embodiment of the invention. In block 400 a memory card or other memory or mass storage device may be inserted into a handset. In block 402, a determination may be made as to whether the handset includes an automatic detection function that scans a new or changed card inserted in the handset. If the handset includes such a function, the method may continue to block 404. If no automatic detection function is available or working in the handset, the method may continue to block 406. In block 404, an automated run function may for example initiate an installer from the card. The installer may for example look for a driver on the handset that may for example operate a memory card. In block 410, a memory slot driver may be found, and the installer may collect from such driver an indication of an operating system, firmware and other identification information of the handset. If no driver is found, the method may continue to block 412, where the installer may look for another driver such as for example a GSM modem driver, that may contain or store the relevant handset data.

In some embodiments, the method may continue to block 414 where the information collected by the application from the handset is assembled into a profile of the handset. Such profile may be used by the installer for selecting a version of one or more applications that are compatible with the operating system and firmware of the handset. In block 416 a determination may be made as to whether the selected version of the application is found on the memory card. If the selected version is found on the card, the method may continue to block 420.

If the selected version is not found on the memory card, the method may proceed to block 418 where the installer or some other program may issue a signal to the handset to send a message over for example a cellular network to a remote device such as a server, requesting that the server transmit to the handset the selected version of the application. In some embodiments, an installer may prompt a user of the handset to approve retrieving a selected version from a remote server. The method may then continue to block 420.

In block 420, the selected version of the application may be installed on the handset. The selected version may have been found in the versions that were stored on the memory card, or it may have been retrieved from a remote server. In block 422, other applications that may be stored on the card or retrieved from a remote server may be installed on the handset, where such versions of the applications are compatible with the profile of the handset assembled by the installer.

In block 424 versions of applications that are not compatible with the profile of the handset may be deleted from the card, for example to make room for other data or applications that a user may want to store on the card.

In some embodiments, the installer or another application on the card that is installed into the handset may serve as a master installer or gate keeper for applications that are downloaded or stored on the memory card. For example, the card may only permit a pre-defined list of applications to be downloaded and stored on the card.

It will be appreciated by persons skilled in the art that embodiments of the invention are not limited by what has been particularly shown and described hereinabove.

We claim:

1. A device comprising:
a memory suitable for inserting into and removing from a handset, said memory having stored thereon instructions that when executed result in:
identifying an operating system and firmware of said handset;
selecting an application stored on said memory, said application compatible with said operating system and said firmware; and
installing said application on said handset.

2. The device as in claim 1, wherein said application comprises a first application, and wherein said first application comprises instructions that when executed result in:
selecting a second application stored on said memory, said second application compatible with said operating system and said firmware,
prompting a user of said handset to approve installation of said second application on said handset; and
installing said second application on said handset.

3. The device as in claim 1, wherein said application comprises a first application, and wherein a second application comprises instructions that when executed result in wirelessly receiving data from a remote device, said data to update information stored on said handset.

4. The device as in claim 1, wherein said application comprises a first application, and wherein a second application comprises instructions that when executed result in said handset wirelessly transmitting data to a remote device, said data including information on advertisement views of said handset.

5. The device as in claim 1, wherein execution of said instructions results in selecting said application operable by said operating system from among a plurality of versions of said application stored on said device, said plurality of versions operable by a plurality of other operating systems.

6. The device as in claim 1, wherein said identifying comprises collecting data from said handset, said data selected from the group consisting of a phone number of said handset, a model of said handset, identification data of said device, a host operator of said handset and a geographical area of operation of said handset.

7. The device as in claim 1, wherein execution of said instructions results in transmitting to a remote device data selected from the group consisting of a phone number of said handset, a model of said handset, identification data of said device, a host operator of said handset and an area of operation of said handset.

8. The device as in claim 1, said memory having stored thereon instructions that when executed result in blocking from said memory data that does not match a pre-defined criteria.

9. The device as in claim 1, wherein execution of said instructions results in deleting from said memory a version of said application, said version not installed on said handset.

10. A device comprising:
a memory suitable for inserting into and removing from a handset, said memory having stored thereon instructions that when executed result in:
identifying an operating system and firmware of said handset;
wirelessly transmitting a signal to a remote device, said signal requesting to receive an application, said application compatible with said operating system and said firmware; and
installing said application on said handset.

11. The device as in claim 10, wherein said application comprises a first application, and wherein said first application selects a second application, said second application stored on said device, and said second application compatible with said operating system and said firmware.

12. The device as in claim 10, wherein said application is to delete from said device versions of said application that are not compatible with said operating system and said firmware.

13. A method comprising:
executing on a handset an instruction stored on a memory, said memory suitable for insertion into and removal from said handset;
identifying an operating system and firmware of a handset;
selecting an application stored on said memory, said application compatible with said operating system and said firmware; and
installing said application on said handset.

14. The method as in claim 13, wherein said application comprises a first application, said method further comprising:
selecting a second application stored on said memory, said second application compatible with said operating system and said firmware,
prompting a user of said handset to approve installation of said second application on said handset; and
installing said second application on said handset.

15. The method as in claim 13, wherein said application comprises a first application, and wherein said method further comprises wirelessly receiving data from a remote device, said data to update information stored on said handset.

16. The method as in claim 13, wherein said application comprises a first application, said method comprising wirelessly transmitting data from said handset to a remote device, said data including information on advertisement views of said handset.

17. The method as in claim 13, wherein said selecting comprises selecting said application operable by said operating system from among a plurality of versions of said application stored on said memory, said plurality of versions operable by a plurality of other operating systems.

18. The method as in claim 13, wherein said identifying comprises collecting data from said handset, said data selected from the group consisting of a phone number of said handset, a model of said handset, identification data of said memory, a host operator of said handset and a geographical area of operation of said handset.

19. The method as in claim 13, wherein comprising transmitting to a remote device data selected from the group consisting of a phone number of said handset, a model of said handset, identification data of said memory, a host operator of said handset and an area of operation of said handset.

20. The method as in claim 13, said method further comprising blocking from storage on said memory data that does not match a pre-defined criteria.
